(19) United States
(12) Patent Application Publication
(10) Pub. No.: US 2026/0261900 A1
(43) Pub. Date: Sep. 3, 2026

(54) RAPID NETWORK DEPLOYMENT AND CONTENT AUGMENTATION VIA TEMPORARILY EXPOSING CORE FUNCTIONALITY FOR ENHANCED QOS

(71) Applicant: AT&T Intellectual Property I, L.P., Atlanta, GA (US)

(72) Inventors: Joseph Soryal, Glendale, NY (US); Howard L. Lang, Wayside, NJ (US); Venson Shaw, Kirkland, WA (US)

(73) Assignee: AT&T Intellectual Property I, L.P., Atlanta, GA (US)

(21) Appl. No.: 19/068,735

(22) Filed: Mar. 3, 2025

(51) Int. Cl. H04W 28/02; H04L 41/0896; H04L 41/50; H04L 41/5067; H04W 28/20

(52) U.S. Cl. CPC H04W 28/0268; H04L 41/0896; H04L 41/5032; H04L 41/5067; H04W 28/20

(57) ABSTRACT

Aspects of the subject disclosure may include, for example: obtaining data characterizing end-user device usage at an edge node of a communications network; responsive to a determination that the end-user device usage would benefit from an adjustment to the communications network, selecting at least one core network function to instantiate at the edge node as the adjustment, wherein the selecting results in a selected network function; causing an instantiation of the selected network function at the edge node; and responsive to the instantiation of the selected network function at the edge node, dynamically generating an application programming interface (API) configured for controlling the selected network function that had been instantiated at the edge node. Other embodiments are disclosed.

### FIELD OF THE DISCLOSURE

The subject disclosure relates to rapid network deployment and content augmentation via temporarily exposing core functionality for enhanced QoS (Quality of Service).

### BACKGROUND

A conventional fifth-generation (5G) network architecture comprises a number of core virtual network functions, including: Network Slice Selection Function (NSSF), Network Exposure Function (NEF), Network Function Repository Function (NRF), Policy Control Function (PCF), Unified Data Repository (UDR), Application Function (AF), Authentication Server Function (AUSF), Access and Mobility Management Function (AMF), and Session Management Function (SMF).

Further, certain conventional application programming interface (API) mechanisms have traditionally been limited in only addressing one need or sub-category of engineering elements.

Moreover, a distributed wireless model is gaining traction where individual users purchase, deploy and operate their own wireless access points to provide local coverage for an incentive/reward. Under such a distributed wireless model, the distributed wireless elements often meet at a central platform which processes recording and accounting of the incentive/reward transaction. In addition, this central platform often aggregates the log data in terms of network capabilities, individual node's up time, delay, locations, rewards earned, etc. In many of the traditional distributed network models, the central platform is powered by a blockchain layer/infrastructure.

### BRIEF DESCRIPTION OF THE DRAWINGS

Reference will now be made to the accompanying drawings, which are not necessarily drawn to scale, and wherein:

FIG. 1 is a block diagram illustrating an example non-limiting embodiment of a communication network in accordance with various aspects described herein.

FIG. 2A is a block diagram illustrating an example, non-limiting embodiment of a system (which can function within the communication network of FIG. 1) in accordance with various aspects described herein.

FIG. 2B is a block diagram illustrating an example, non-limiting embodiment of a system (which can function within the communication network of FIG. 1) in accordance with various aspects described herein.

FIG. 2C is a block diagram illustrating an example, non-limiting embodiment of a system (which can function within the communication network of FIG. 1) in accordance with various aspects described herein.

FIG. 2D is a block diagram illustrating an example, non-limiting embodiment of a system (which can function within the communication network of FIG. 1) in accordance with various aspects described herein.

FIG. 2E depicts an illustrative embodiment of a method in accordance with various aspects described herein.

FIG. 2F depicts an illustrative embodiment of a method in accordance with various aspects described herein.

FIG. 2G depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for movement of one or more core functions to an edge of a communications network and/or implementation of dynamic API creation/usage. Other embodiments are described in the subject disclosure.

One or more aspects of the subject disclosure include a layered approach to provide the ability of the core functions to be transported to the front line (e.g., compute resources on the ORAN) to be close to the subscribers and to thus reduce bidirectional traffic and minimize latency.

One or more aspects of the subject disclosure include a device, comprising: a processing system including a processor; and a memory that stores executable instructions that, when executed by the processing system, facilitate performance of operations, the operations comprising: obtaining data characterizing end-user device usage at an edge node of a communications network; analyzing the data to determine whether the end-user device usage would benefit from an adjustment to the communications network, resulting in a determination; responsive to the determination being that the end-user device usage would benefit from the adjustment to the communications network, selecting from among a plurality of core network functions at least one core network function to instantiate at the edge node as the adjustment, wherein the selecting results in a selected network function; causing an instantiation of the selected network function at the edge node, wherein the instantiation leaves as operating for other end-user device usage that is not at the edge node the at least one core network function; and responsive to the instantiation of the selected network function at the edge node, dynamically generating an application programming interface (API) configured for controlling the selected network function that had been instantiated at the edge node.

One or more aspects of the subject disclosure include a non-transitory machine-readable medium comprising executable instructions that, when executed by a processing system including a processor, facilitate performance of operations, the operations comprising: determining, based upon attach messages associated with a radio access network (RAN) node of a wireless communications system, a number of mobile communications devices communicating with the RAN node; comparing the number of mobile communications devices communicating with the RAN node to a threshold, wherein the comparing results in a determination; responsive to the determination being that the number of mobile communications devices communicating with the RAN node meets the threshold, instantiating at the RAN node one or more proxy core network functions, wherein the one or more proxy core network functions comprise: an Authentication Server Function (AUSF), a Policy Control Function (PCF), or any combination thereof; and responsive to the instantiation of the one or more proxy core network functions at the RAN node, dynamically generating an application programming interface (API) configured for controlling the one or more proxy core network functions.

One or more aspects of the subject disclosure include a method, comprising: detecting, by a processing system including a processor of a wireless communications network, a first instantiation of a first proxy core network function at an edge node of the wireless communications network; detecting, by the processing system, a second instantiation of a second proxy core network function at the edge node of the wireless communications network, wherein the second proxy core network function is a different function than the first proxy core network function; and dynamically generating in real-time, by the processing system, an application programming interface (API) configured for controlling both the first proxy core network function and the second proxy core network function.

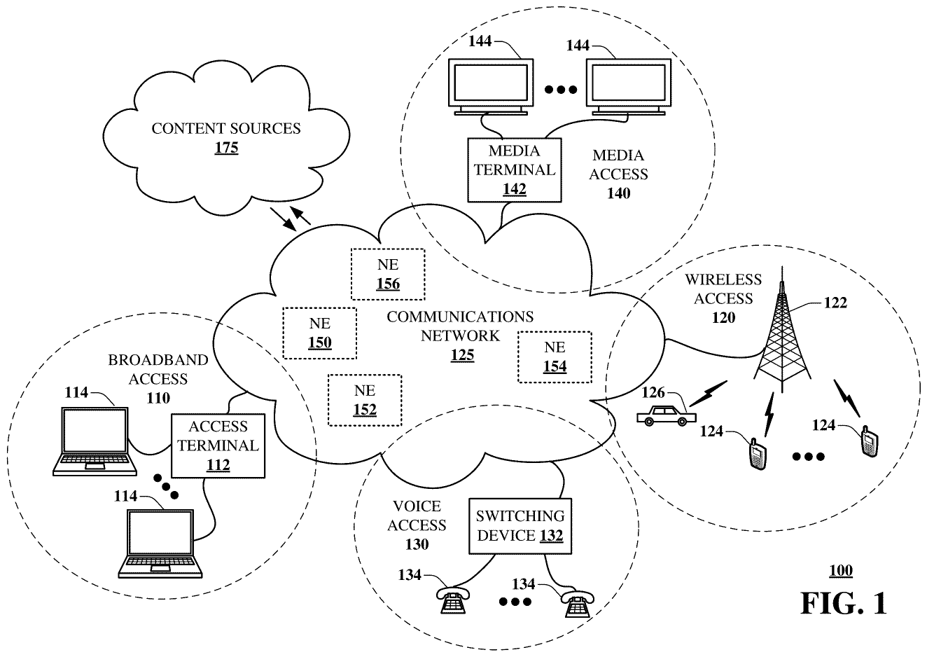

Referring now to FIG. 1, a block diagram is shown illustrating an example, non-limiting embodiment of a system 100 in accordance with various aspects described herein. For example, system 100 can facilitate in whole or in part movement of one or more core functions to an edge of a communications network and/or implementation of dynamic API creation/usage. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

As described herein, various embodiments can provide high QoS (quality of service) connectivity along with high security, on demand in the presence of heavy user consumption.

As described herein, various embodiments can bring core functions to the RAN edge to satisfy customer needs.

As described herein, various embodiments can provide a layered mechanism comprising the following four segments (that can work together or separately):
Move core functions along the communications path to where the link/elements are least congested, including to the front end (e.g., compute resources over the ORAN).
Configure network elements via API Dynamic Interface, wherein each API gets the needs of the whole use case (e.g., the API gets all the needs such as the end points distance and networking in between, bandwidth needed and delay, security levels, etc.). In one embodiment, an API engine can connect with all the network resources to spin up and deploy all the elements needed for the end-to-end pipe from RAN, Transport and Core (all the way to the application server). In one specific example, the API engine can factor in the scarcity of the spectrum at the two endpoints of the communications devices.
Leverage AI (e.g., in a user-facing manner) to augment various content (e.g., in order to overcome a shortage of bandwidth).
Provide security gateway that can move into any path (e.g., depending on the dynamic routing that may be forced because of spectrum scarcity).

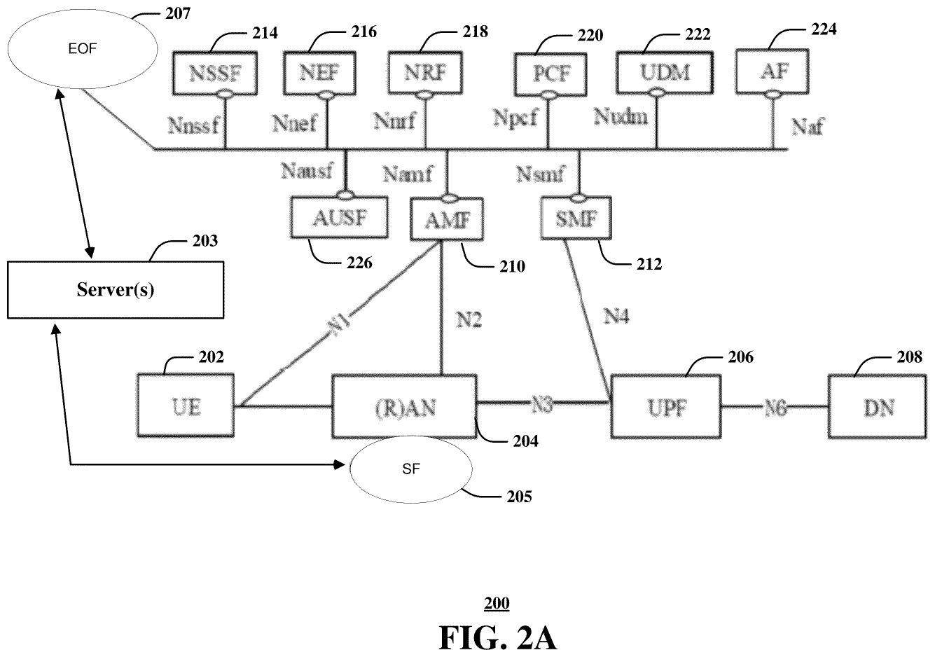

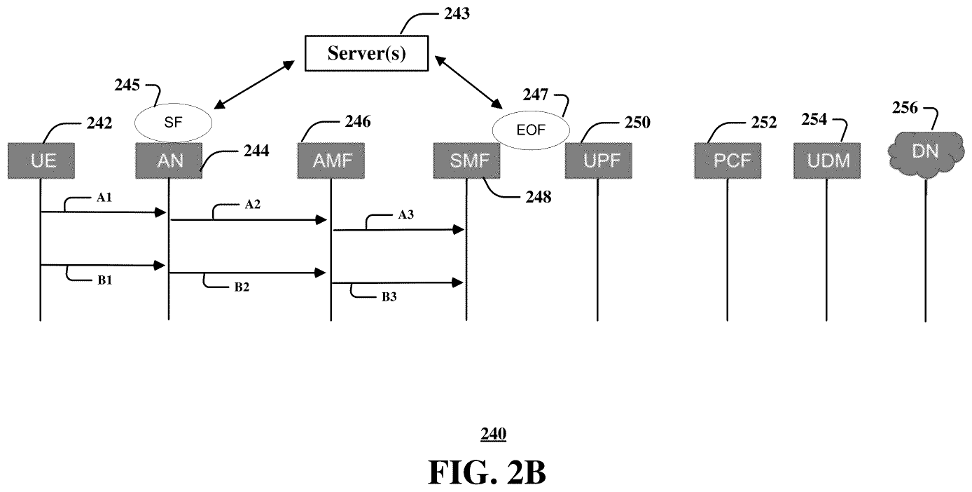

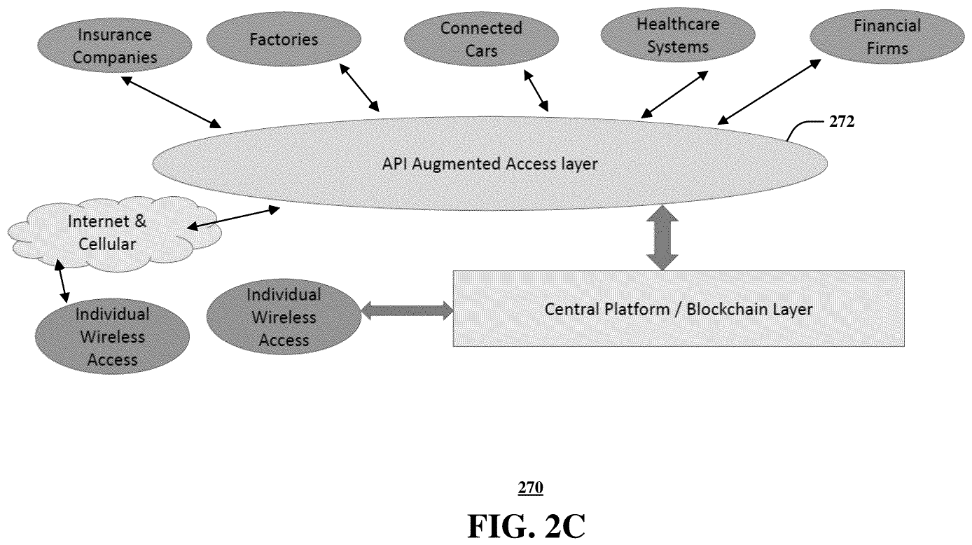

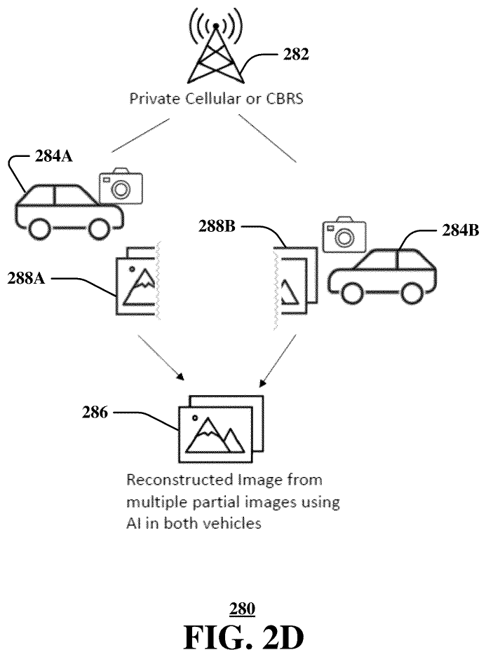

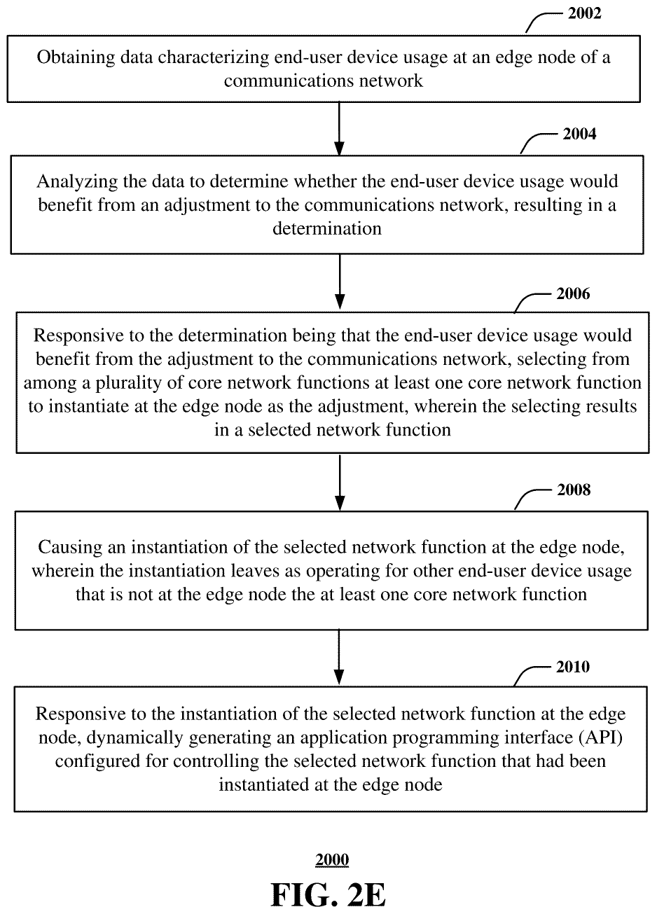

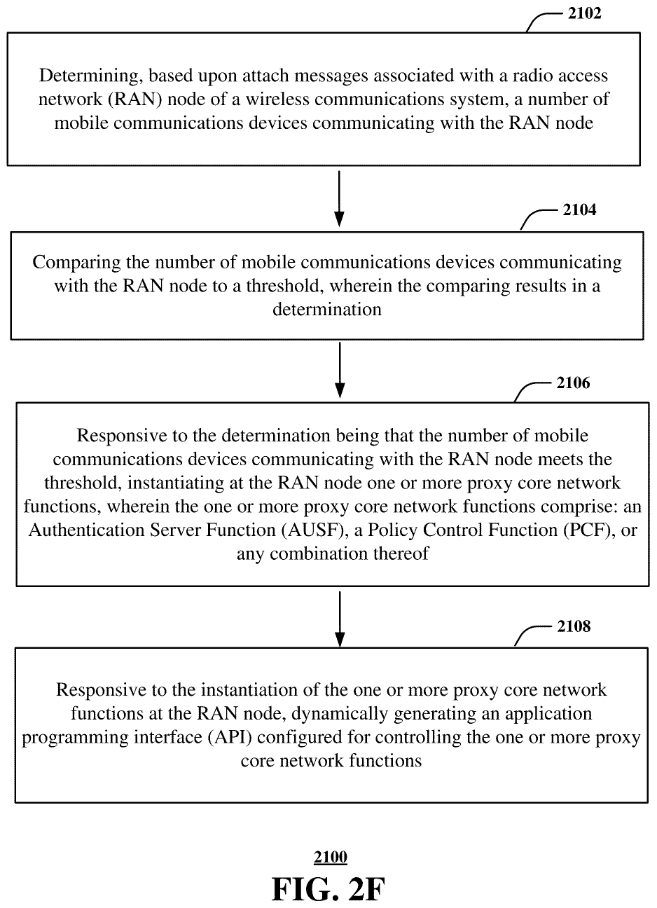

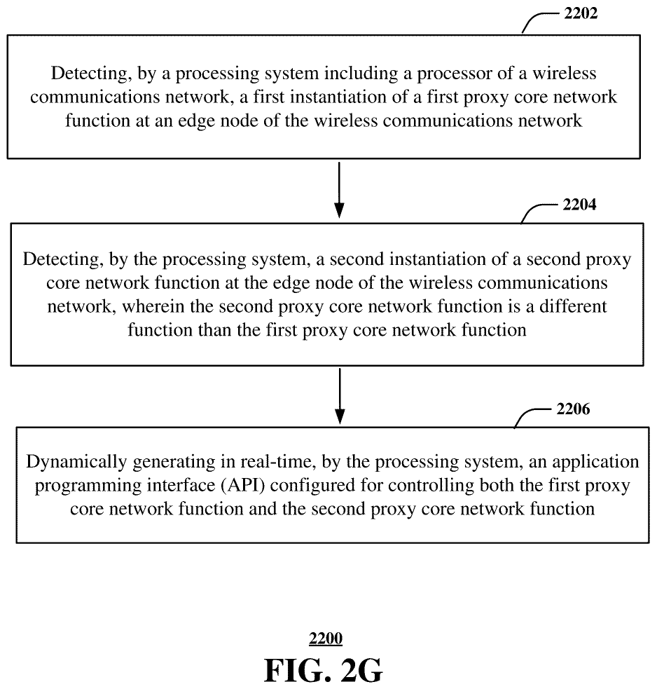

Referring now to FIG. 2A, this is a block diagram illustrating an example, non-limiting embodiment of a system 200 (which can function within the communication network of FIG. 1) in accordance with various aspects described herein. As seen in this figure (which shows an architecture diagram associated with certain 5G Core VNFs for E2E call flow), a UE 202 is configured for bidirectional communications with a Radio Access Network (RAN) 204 of a communications network. The RAN 204 is configured for bidirectional communications with the User Plane Function (UPF) 206 which in turn is configured for bidirectional communications with data network (DN) 208 (which can include operator/3rd party services and/or Internet access). The UE 202 and the RAN 204 are also each configured for bidirectional communications with the Access Mobility and Management Function (AMF) 210 and the UPF 206 is configured for bidirectional communications with the Session Management Function (SMF) 212. As seen, in addition to AMF 210 and SMF 212, the core network also includes the following: Network Slice Selection Function (NSSF) 214, Network Exposure Function (NEF) 216, Network Function Repository Function (NRF) 218, Policy Control Function (PCF) 220, Unified Data Repository (UDR) 222, Application Function (AF) 224, and Authentication Server Function (AUSF) 226. In addition, in this embodiment, Smart Function (SF) 205 is part of (and/or configured for bidirectional communications with) RAN 204 and Element Optimization Function (EOF) 207 is part of (and/or configured for bidirectional communications with) the core network. Further, in this embodiment, each of SF 205 and EOF 207 is configured for bidirectional communications with (and/or is part of) Server(s) 203. In concert, these Server(s) 203, SF 205 and EOF 207 operate (according to various embodiments) to provide function movement, instantiation and tear-down as described herein. Of note, while one SF 205 is shown, any desired number of Smart Functions can be utilized. Moreover, while one EOF 207 is shown, any desired number of Element Optimization Functions can be utilized. In addition, each of SF 205 and EOF 207 can be located (and/or configured for bidirectional communications with) any desired element(s) of the network.

Still referring to FIG. 2A, certain details of a transport operation will now be discussed. More particularly, in one embodiment, one or more functions can temporarily and dynamically move (and/or be subject to instantiation of one or more new proxies) from the core to the ORAN (and/or to other physical spaces on the core). In one example, the ORAN and core platform infrastructure can have enough compute power for many transactions/processes and this compute power can be utilized to reduce service time. A Smart Function (see, e.g., SF 205) can reside at the ORAN (e.g., facing subscribers). This Smart Function can quantify the need for the majority of users via the mobile attach (e.g., UE<->RAN<->MME/AMF). The SF can communicate with the core functions (e.g., individually) and can ask for a proxy for the core functions to be temporarily spun up at the ORAN compute resources to serve subscribers faster and reduce the bandwidth consumption at other locations. In one example, a function can be spun up at the ORAN while copying some of the information from the core's main function to temporarily serve the population of subscribers. In another embodiment, an Element Optimization Function (see, e.g., EOF 207) can reside in the core and can obtain statistics of traffic traversing the core elements/functions. The EOF can perform simulation of anticipated traffic (using, e.g., input from the SF). The EOF can act as a VNF orchestrator, spinning-up the functionality (e.g., after discarding the existing) into a physical location (wherein the EOF can, for example, intercept the traffic in the least used area to enhance traffic viscosity and fluidity).

Referring now to FIG. 2B, this is a block diagram illustrating an example, non-limiting embodiment of a system 240 (which can function within the communication network of FIG. 1) in accordance with various aspects described herein. As seen in this figure (which shows certain process flow features), a UE 242 is configured for bidirectional communications with an Access Network (AN) 244 of a communications network. The communications network also includes AMF 246, SMF 248, UPF 250, PCF 252, UDM 254 and DN 256. In addition, in this embodiment, Smart Function (SF) 245 is part of (and/or configured for bidirectional communications with) AN 244 and Element Optimization Function (EOF) 247 is part of (and/or configured for bidirectional communications with) SMF 248. Further, in this embodiment, each of SF 245 and EOF 247 is configured for bidirectional communications with (and/or is part of) Server(s) 243. In concert, these Server(s) 243, SF 245 and EOF 247 operate (according to various embodiments) to provide function movement, instantiation and tear-down as described herein. Of note, while one SF 245 is shown, any desired number of Smart Functions can be utilized. Moreover, while one EOF 247 is shown, any desired number of Element Optimization Functions can be utilized. In addition, each of SF 245 and EOF 247 can be located at (and/or configured for bidirectional communications with) any desired element(s) of the network.

Still referring to FIG. 2B, certain details of a process flow will now be discussed. More particularly, in one example, the SF 245 can communicate with the EOF 247 to indicate a predicted user demand (see, e.g., arrows A1, A2, A3). In another example, SF 245 can invoke one or more proxy functions to the ORAN platform (see, e.g., arrows B1, B2, B3). In another example, the EOF 247 can obtain traffic congestion current stats (and add predicted traffic demand), then simulate the traffic to optimize the best location for the function(s) on the core (and/or at the network edge). In another example, the EOF 247 can optimize the physical location of the core function(s) in a way that ensures traffic is supported in an optimized manner.

Still referring to FIG. 2B, certain details of a use case will now be discussed. More particularly, in this example, a group of subscribers has just approached the ORAN's wireless coverage area. From the Attach messages, the SF 245 determines (e.g., by monitoring the traffic between the UEs and the AMF 246), that many subscribers will need to be authenticated and will need to receive encryption keys. In response, the SF 245 can invoke an AUSF instance (a “proxy AUSF”) to a node that is nearby the subscribers (e.g., from available compute power at the ORAN). The proxy AUSF can have the subscribers' information that has been gleaned from Attach messages captured by the SF 245. Then, the proxy AUSF can authenticate the subscribers faster and with less backhauled traffic. Later, the proxy AUSF can go back (e.g., be transported) to the main AUSF in the core and can reconcile the records (e.g., so that the main AUSF will have the most up to date information including transactions conducted in the proxy state). When no longer needed, the proxy AUSF can get dissolved.

Still referring to FIG. 2B, certain details of another use case will now be discussed. More particularly, in this example, similar operations can proceed with respect to PCF 252. In this case, wherein users have variable PCF parameters (e.g., geolocation restriction), the SF 245 can invoke the PCF 252 as a proxy PCF to manage the policies of these users and implement any changes to the ORAN directly (e.g., while coordinating with other core functions to execute policies on the core level as well). Of note, while the latter two use cases related to AUSF and PCF, any other core network functions can be moved, instantiated and/or torn down as required.

Referring now to FIG. 2C, this is a block diagram illustrating an example, non-limiting embodiment of a system 270 (which can function within the communication network of FIG. 1) in accordance with various aspects described herein. As seen in this figure (which relates to an API dynamic interface for distributed wireless environments), various embodiments can augment the insights from the individual wireless access points and from the central platform into a single layer. This single layer can expose dynamic and configurable APIs to be consumed by third parties such as, for example, insurance companies, factories, connected cars, healthcare systems, financial firms, etc. More particularly, it is seen that API Augmented Access Layer (or AAAL) 272 is a software application that resides on one or more servers at the service provider's core network (or at another point of presence). The AAAL 272 is connected to the blockchain layer via a dedicated link (e.g., fiber optic) and also connected to the individual wireless access points either via the Internet or via the blockchain layer. The AAAL 272 actively pulls the API values and forwards them to third party entities, and/or can be reactive so when a third party entity requests a value of one or more APIs, then the AAAL 272 forwards the queries to the blockchain platform and to the individual wireless access points. The AAAL 272 has a user interface for the system manager to specify the APIs package required by a third party and can configure the frequency of the queries and access level and authentication credentials for the third party server to access the AAAL 272.

Still referring to FIG. 2C, certain details of operation will now be described. More particularly, once the system admin configures the third party credential and access, a link will be established between the AAAL 272 and the respective third party application server that will pull the API values. The AAAL 272 can prepare the APIs as a bundle for a complete “experience” to the API consumer. The AAAL 272, based on an intelligent insight engine (an AI module that can simulate the third party bundle) can recommend more APIs to be added to the bundle provided to the third party to enhance the experience. The AAAL 272 can provide the central/blockchain platform with details of each API query and response to be recorded inside the distributed ledger model. The AAAL 272 can track the API queries sent to the individual wireless gateways and then it can provide the central/blockchain layer with a periodic count of API queries to provide incentives to the individual nodes.

Referring now to FIG. 2D, this is a block diagram illustrating an example, non-limiting embodiment of a system 280 (which can function within the communication network of FIG. 1) in accordance with various aspects described herein. As seen, this figure relates to content augmentation. More particularly, in various embodiments, the infrastructure of the Private Cellular or CBRS (Citizens Broadband Radio Service) network 282 is loaned to the vehicles 284A, 284B while traversing the coverage area to provide an artificial intelligence platform for the vehicles 284A, 284B. This artificial intelligence platform can facilitate one or more of the following operations: (a) reconstruct a complete image 286 from an incomplete image 288A and an incomplete image 288B (wherein each of the images was originally incomplete, for example, because they were captured while there was an obstructive object such as a truck, a pedestrian, tree, etc.); and/or (b) authenticate images shared by vehicles amongst each other to the road and/or other mobile objects. In various embodiments, the incomplete image 288A can comprise a plurality of incomplete images, the incomplete image 288B can comprise a plurality of incomplete images, and the complete image 286 can comprise a plurality of complete images. In various embodiments, each of the images can be captured by a respective camera (e.g., a camera placed in and/or integrated with vehicle 284A, a camera placed in and/or integrated with vehicle 284B). In various embodiments, each of the images comprises a still image, a video image, or any combination thereof. In one embodiment, the artificial intelligence platform can be offered by a wireless carrier on top of a communications infrastructure that is deployed on the roads. In another embodiment, the artificial intelligence platform on the private cellular or CBRS infrastructure can be used for one or more other purposes as needed by the vehicles. In various embodiments, each vehicle can comprise: a car a truck, a bus, an autonomous vehicle, or any combination thereof.

Reference will now be made to certain details of a process to reconstruct incomplete images according to various embodiments. More particularly, if a vehicle's vision (that is, a view provided by a vehicle's camera) is impeded by obstructive object(s), the vehicle can send the incomplete image taken to the AI platform which will employ image processing to attempt to reconstruct the full image and determine what is hidden. In one example, the AI processing can occur in real-time (or essentially real-time) to assist the vehicles in making the best decision based on the information given. In one example, the private core (and/or CBRS infrastructure) is connected to cameras to help visualize, for instance, a whole intersection as well as incoming and outgoing traffic and other mobile objects which will be taken into account when the incomplete image is sent by one car to the AI platform to process. In one example, the AI platform can anticipate the need for these images of the sections of the road and will be prepared to complete those incomplete images taken by the vehicles.

Reference will now be made to certain details of a process to authenticate images (e.g., shared by vehicles amongst each other and/or to the road and other mobile objects) according to various embodiments. More particularly, the AI platform can function as an authenticator to ensure that vehicle to vehicle communications for image sharing is authentic and that these images are not maliciously manipulated. In one embodiment, when a vehicle sends an image to another vehicle, it can send a copy as well to the AI platform (the AI platform, with knowledge and observations that have been accumulated, will either agree or disagree that the sender vehicle is accurate/authentic). If the AI platform finds something suspicious, it can broadcast an alarm alerting all vehicles (and other AI platforms) that this particular vehicle has provided manipulated image(s) of the roads. An AI platform as described herein can be used because it is likely that all images taken by the vehicles would not 100% match (given the angle the image was taken from, speed and other mobile objects in the frame). In this scenario, the AI platform can analyze these images and ensure that the images could have happened (e.g., vehicle 1 shares an image of an empty pedestrian crosswalk, but vehicle 2 after 30 seconds shares the same shot in which there are now pedestrians—the AI platform can account for the dynamic changes in the environment).

Reference will now be made to certain details of an AI platform according to various embodiments. More particularly, the AI platform can comprise a general-purpose AI platform that can coexist with a private core of a private cellular network. In one example, vehicles can subscribe to the AI platform by subscribing to the service with a wireless provider (and/or with whatever entity offers a private cellular network infrastructure). Each subscribed vehicle can have a unique token assigned at a registration time. When a given subscribed vehicle enters a coverage area with the AI platform, the vehicle can send the private core the subscription token, wherein the AI platform will then grant processing resources to this vehicle (the resources can be discarded after the vehicle leaves this coverage area). The AI platform can notify the next private cellular network along the road to prepare similar resources to the same vehicle (e.g., based on the vehicle's movement direction). The AI platform in the first private cellular network can relay any unfinished computations to the second AI platform along with finished results/learned materials from training aspects. The AI platforms can all communicate together and with a backend server. At the end of a given vehicle's trip, all the information (e.g., results and experience) can be stored in the backend server for that particular user and correlated per intersection/coverage area.

Referring now to FIG. 2E, various steps of a method 2000 according to an embodiment are shown. As seen in this FIG. 2E, step 2002 comprises obtaining data characterizing end-user device usage at an edge node of a communications network. Next, step 2004 comprises analyzing the data to determine whether the end-user device usage would benefit from an adjustment to the communications network, resulting in a determination. Next, step 2006 comprises responsive to the determination being that the end-user device usage would benefit from the adjustment to the communications network, selecting from among a plurality of core network functions at least one core network function to instantiate at the edge node as the adjustment, wherein the selecting results in a selected network function. Next, step 2008 comprises causing an instantiation of the selected network function at the edge node, wherein the instantiation leaves as operating for other end-user device usage that is not at the edge node the at least one core network function. Next, step 2010 comprises responsive to the instantiation of the selected network function at the edge node, dynamically generating an application programming interface (API) configured for controlling the selected network function that had been instantiated at the edge node.

While for purposes of simplicity of explanation, the respective processes are shown and described as a series of blocks in FIG. 2E, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Referring now to FIG. 2F, various steps of a method 2100 according to an embodiment are shown. As seen in this FIG. 2F, step 2102 comprises determining, based upon attach messages associated with a radio access network (RAN) node of a wireless communications system, a number of mobile communications devices communicating with the RAN node. Next, step 2104 comprises comparing the number of mobile communications devices communicating with the RAN node to a threshold, wherein the comparing results in a determination. Next, step 2106 comprises responsive to the determination being that the number of mobile communications devices communicating with the RAN node meets the threshold, instantiating at the RAN node one or more proxy core network functions, wherein the one or more proxy core network functions comprise: an Authentication Server Function (AUSF), a Policy Control Function (PCF), or any combination thereof. Next, step 2108 comprises responsive to the instantiation of the one or more proxy core network functions at the RAN node, dynamically generating an application programming interface (API) configured for controlling the one or more proxy core network functions.

While for purposes of simplicity of explanation, the respective processes are shown and described as a series of blocks in FIG. 2F, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Referring now to FIG. 2G, various steps of a method 2200 according to an embodiment are shown. As seen in this FIG. 2G, step 2202 comprises detecting, by a processing system including a processor of a wireless communications network, a first instantiation of a first proxy core network function at an edge node of the wireless communications network. Next, step 2204 comprises detecting, by the processing system, a second instantiation of a second proxy core network function at the edge node of the wireless communications network, wherein the second proxy core network function is a different function than the first proxy core network function. Next, step 2206 comprises dynamically generating in real-time, by the processing system, an application programming interface (API) configured for controlling both the first proxy core network function and the second proxy core network function.

While for purposes of simplicity of explanation, the respective processes are shown and described as a series of blocks in FIG. 2G, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

As described herein, various embodiments can facilitate movement of one or more core functions along the communications path where the link/elements are least congested including to the front end (e.g., utilizing compute resources over the ORAN).

As described herein, various embodiments can address the QoS needs in an area in which the wireless coverage is otherwise (that is, without use of various embodiments) not optimum. In various examples, the area in which QoS needs can be addressed includes roadways, edges of cities and/or urban areas where installing RAN towers is expensive.

As described herein, various embodiments can be integrated into one or more private cellular networks (e.g., to cover segments of the roads using carrier aggregation combining CBRS and licensed carrier spectrum). In various examples, the private cellular networks can comprise one or more micro cell towers that communicate with vehicles for the period of time that these vehicles are in a given coverage area. In various examples (e.g., to enhance the data sharing between the vehicles within a given coverage area), the network can be utilized to validate the roadway information between vehicles in the coverage area. In various examples, data integrity can be provided between the vehicles with the assistance of the private cellular network infrastructure.

As described herein, various embodiments can facilitate an increase in link/bandwidth utilization (which can enhance user experience without adding to the infrastructure).

As described herein, various embodiments can efficiently use cloud resources based on demand only.

As described herein, in various embodiments the dynamically generated API can be configured to provide real-time monitoring and control of the selected network function(s), including adjusting parameters such as bandwidth allocation, latency thresholds, and security protocols based on current network conditions.

As described herein, in various embodiments the selected network function(s) instantiated at the edge node include a mechanism for load balancing across multiple edge nodes, thereby optimizing resource utilization and enhancing the overall quality of service (QoS) for end-user devices.

As described herein, in various embodiments mechanisms can be provided for predicting future network demands at the edge node using machine learning algorithms, and preemptively instantiating additional core network function(s) to accommodate anticipated increases in end-user device usage.

As described herein, various embodiments can operate in an end-to-end context for a service (e.g., along a communication line that extends from the UE all the way to the core, then to the application server).

As described herein, various embodiments can facilitate enhancement of service (e.g., by reducing delay) and at the same time providing security (e.g., by instantiating a firewall locally at an edge node (or other access point) on demand when required).

As described herein, various embodiments can transport functions based on physical distance and/or logical links (e.g., to move away from congestion).

As described herein, various embodiments can dynamically transport functions from a core to an edge, from an edge to a core, and/or from one core to another core.

As described herein, various embodiments can dynamically transport functions, wherein a given function is transported along with certain knowledge of historic parameters, characteristics, users, subscribers, usage (e.g., certain subscribers use a large amount of video bandwidth), operations, and/or the like. The knowledge can be transported via entries in a database and/or via spinning up a cached copy in a new location.

As described herein, various embodiments can dynamically transport a function in a form of a proxy (e.g., while maintaining a version of the original function at the original location).

As described herein, various embodiments can transport functions dynamically on demand and/or per user session for specific tasks.

As described herein, various embodiments can facilitate enhancement of service using a single dynamically generated API (e.g., to raise a QoS via a temporarily updated: PCF; AMF and/or MMME (e.g., to accept more traffic); and/or priority level). In one embodiment, a single API can command the RAN and the core simultaneously (without requiring multiple APIs).

As described herein, various embodiments can generate an API taking into account dynamic situational awareness (in order to, for example, implement traffic shaping and/or pruning).

As described herein, various embodiments can generate an API using one or more interfaces from one or more sources (e.g., finding a published interface agreement on the Internet).

As described herein, various embodiments can operate in the context of mobility wireless (e.g., 5G, 6G) and/or in the context of broadband. In one example, the operation can be on-demand.

As described herein, various embodiments can facilitate fraud detection (e.g., with regard to robo calls). In one example, the fraud detection can be from the perspective of the user/subscriber.

As described herein, various embodiments can operate in the context of: a wireless provider telecommunication core; a cloud-based system; a client-server system; or any combination thereof.

As described herein, various embodiments can operate in the context of blockchains and/or distributed ledgers.

As described herein, various embodiments can operate in the context of distributed augmented core functions.

As described herein, various embodiments can facilitate crowdsourcing such that fragments (or portions) of images are combined into a more complete picture (e.g., as a physical image and/or as a logical (or abstract) description of a situation or concept).

As described herein, various embodiments can provide a mechanism to authenticate via AI.

As described herein, various embodiments can operate in the form of a digital agent.

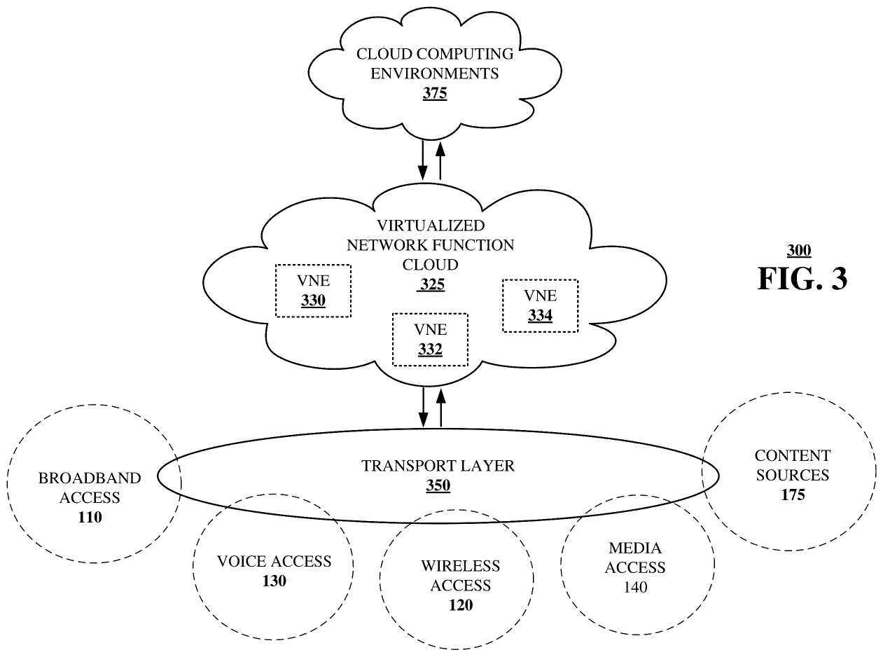

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of systems 100, 200, 240, 270, 280, and/or some or all of the functions of methods 2000, 2100, 2200. For example, virtualized communication network 300 can facilitate in whole or in part movement of one or more core functions to an edge of a communications network and/or implementation of dynamic API creation/usage.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

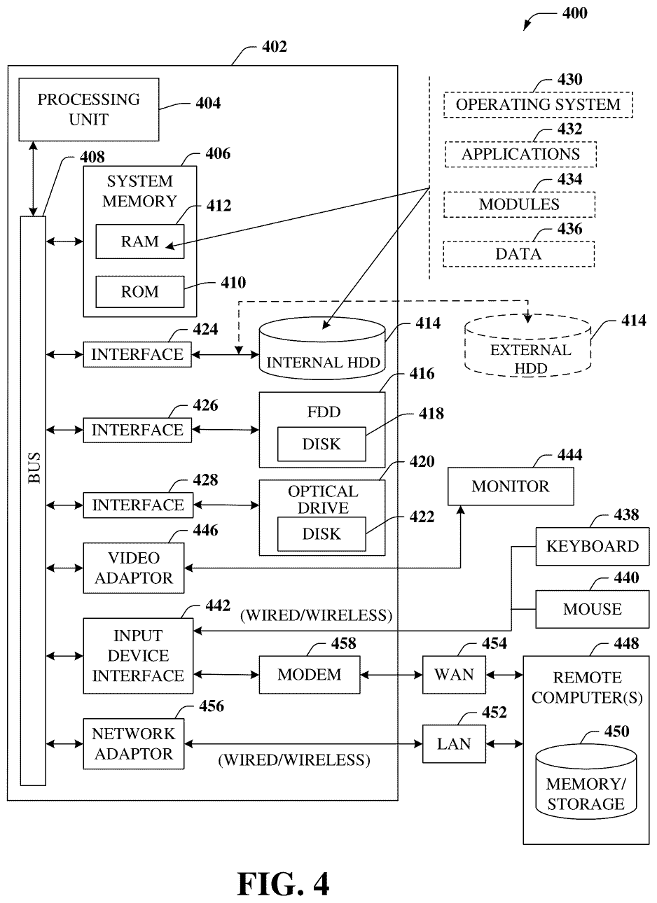

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part movement of one or more core functions to an edge of a communications network and/or implementation of dynamic API creation/usage.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

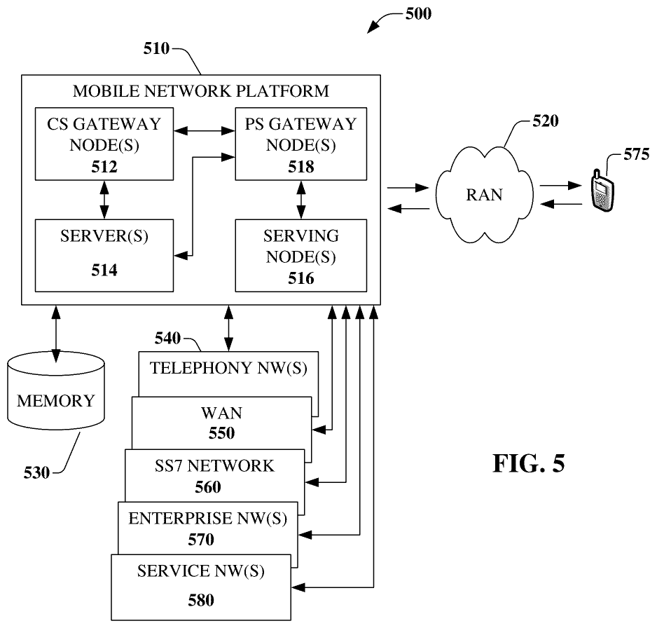

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part movement of one or more core functions to an edge of a communications network and/or implementation of dynamic API creation/usage. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

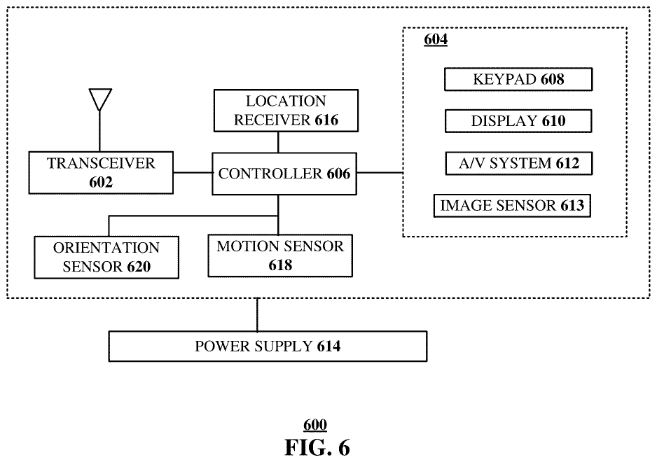

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part movement of one or more core functions to an edge of a communications network and/or implementation of dynamic API creation/usage.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” “data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically moving of one or more core functions to an edge of a communications network and/or automatically implementing dynamic API creation/usage) can employ various AI-based schemes for carrying out various embodiments thereof. Moreover, a classifier can be employed to determine a ranking or priority of each core function, end-user, and/or API. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the core function(s), end-user(s), and/or API(s) is to receive priority.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” “subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” “data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
obtaining data characterizing end-user device usage at an edge node of a communications network;
analyzing the data to determine whether the end-user device usage would benefit from an adjustment to the communications network, resulting in a determination;
responsive to the determination being that the end-user device usage would benefit from the adjustment to the communications network, selecting from among a plurality of core network functions at least one core network function to instantiate at the edge node as the adjustment, wherein the selecting results in a selected network function;
causing an instantiation of the selected network function at the edge node, wherein the instantiation leaves as operating for other end-user device usage that is not at the edge node the at least one core network function; and
responsive to the instantiation of the selected network function at the edge node, dynamically generating an application programming interface (API) configured for controlling the selected network function that had been instantiated at the edge node.

2. The device of claim 1, wherein the causing the instantiation of the selected network function and the dynamically generating the API each occur in real-time.

3. The device of claim 2, wherein the causing the instantiation of the selected network function and the dynamically generating the API occur substantially contemporaneously.

4. The device of claim 1, wherein the data characterizing the end-user device usage relates to a plurality of mobile communications devices.

5. The device of claim 4, wherein each mobile communications device comprises a respective one of: a smartphone; a cellular phone; a tablet computer; a laptop computer; a notebook computer; a communications element of a vehicle; or any combination thereof.

6. The device of claim 4, wherein the data characterizing the end-user device usage identifies for each mobile communications device of the plurality of mobile communications devices at least one of:
one or more historic positions of a respective mobile communications device; a current position of a respective mobile communications device; one or more future predicted positions of a respective mobile communications device; or any first combination thereof;
one or more historic directions of movement of a respective mobile communications device; a current direction of movement of a respective mobile communications device; one or more future predicted directions of movement of a respective mobile communications device; or any second combination thereof;
one or more historic speeds of movement of a respective mobile communications device; a current speed of movement of a respective mobile communications device; one or more future predicted speeds of movement of a respective mobile communications device; or any third combination thereof;
one or more historic bandwidth consumptions of a respective mobile communications device; a current bandwidth consumption of a respective mobile communications device; one or more future predicted bandwidth consumptions of a respective mobile communications device; or any fourth combination thereof; and
one or more historic frequency range usages of a respective mobile communications device; a current frequency range usage of a respective mobile communications device; one or more future predicted frequency range usages of a respective mobile communications device; or any fifth combination thereof.

7. The device of claim 1, wherein the communications network comprises a wireless cellular communications network.

8. The device of claim 7, wherein the wireless cellular communications network comprises one of: a fourth generation (4G) wireless cellular network; a fifth generation (5G) wireless cellular network; a sixth generation (6G) wireless cellular network; a subsequent generation wireless cellular network; or any combination thereof.

9. The device of claim 1, wherein the analyzing is performed by one of: an artificial intelligence (AI) process; a generative AI process; a machine learning (ML) process; or a combination thereof.

10. The device of claim 1, wherein the benefit from the adjustment to the communications network comprises at least one end-user device receiving an improved quality of service (QOS) as compared to a QOS that would have been received in an absence of the adjustment.

11. The device of claim 10, wherein:
there are a number X end-user devices at the edge node;
the determination being that the end-user device usage would benefit from the adjustment to the communications network comprises a number Y end-user devices receiving the improved QOS;
the numbers X and Y are integers; and
Y is at least half the value of X.

12. The device of claim 1, wherein the plurality of core network functions from which the selected network function is selected comprises: a Network Slice Selection Function (NSSF); a Network Exposure Function (NEF); a Network Function Repository Function (NRF); a Policy Control Function (PCF); a Unified Data Repository (UDR); an Application Function (AF); an Authentication Server Function (AUSF); an Access and Mobility Management Function (AMF); and a Session Management Function (SMF).

13. The device of claim 1, wherein the operations further comprise:
determining that the adjustment to the communications network is no longer required; and
responsive to the determining that the adjustment to the communications network is no longer required, terminating the selected network function that had been instantiated at the edge node.

14. The device of claim 1, wherein:
the selecting comprises selecting a plurality of core network functions to instantiate at the edge node as the adjustment, resulting in a plurality of selected network functions;
the operations further comprise causing a respective instantiation of each of the plurality of selected network functions at the edge node; and
responsive to the instantiation of each of the plurality of selected network functions at the edge node, dynamically generating the API configured for controlling all of the plurality of selected network functions that had been instantiated at the edge node.

15. The device of claim 1, wherein the operations further comprise:
receiving at the edge node a first image that comprises a first portion of a scene, wherein the first image is received from a first vehicle;
receiving at the edge node a second image that comprises a second portion of the scene, wherein the second image is received from a second vehicle; and
aggregating the first image and the second image to generate a complete image of the scene, wherein the aggregating is performed by one of: an artificial intelligence (AI) process; a generative AI process; a machine learning (ML) process; or a combination thereof.

16. The device of claim 15, wherein the operations further comprise:
sending from the edge node to the first vehicle the complete image, wherein the complete image facilitates autonomous operation by the first vehicle; and
sending from the edge node to the second vehicle the complete image, wherein the complete image facilitates autonomous operation by the second vehicle.

17. A non-transitory machine-readable medium comprising executable instructions that, when executed by a processing system including a processor, facilitate performance of operations, the operations comprising:
determining, based upon attach messages associated with a radio access network (RAN) node of a wireless communications system, a number of mobile communications devices communicating with the RAN node;
comparing the number of mobile communications devices communicating with the RAN node to a threshold, wherein the comparing results in a determination;
responsive to the determination being that the number of mobile communications devices communicating with the RAN node meets the threshold, instantiating at the RAN node one or more proxy core network functions, wherein the one or more proxy core network functions comprise: an Authentication Server Function (AUSF), a Policy Control Function (PCF), or any combination thereof; and
responsive to the instantiation of the one or more proxy core network functions at the RAN node, dynamically generating an application programming interface (API) configured for controlling the one or more proxy core network functions.

18. The non-transitory machine-readable medium of claim 17, wherein the operations further comprise:
determining a subsequent number of mobile communications devices communicating with the RAN node, wherein the subsequent number is determined after the instantiation of the one or more proxy core network functions;
comparing the subsequent number to the threshold, wherein the comparing of the subsequent number results in a subsequent determination; and
responsive to the subsequent determination being that the subsequent number of mobile communications devices communicating with the RAN node does not meet the threshold, tearing-down at the RAN node the one or more proxy core network functions.

19. A method, comprising:
detecting, by a processing system including a processor of a wireless communications network, a first instantiation of a first proxy core network function at an edge node of the wireless communications network;
detecting, by the processing system, a second instantiation of a second proxy core network function at the edge node of the wireless communications network, wherein the second proxy core network function is a different function than the first proxy core network function; and
dynamically generating in real-time, by the processing system, an application programming interface (API) configured for controlling both the first proxy core network function and the second proxy core network function.

20. The method of claim 19, wherein:
the first proxy core network function is an Authentication Server Function (AUSF);
the second proxy core network function is a Policy Control Function (PCF);
the first instantiation of the first proxy core network function had been responsive to a usage condition present at the edge node;
the second instantiation of the second proxy core network function had been responsive to the usage condition present at the edge node;
the edge node comprises part of a cellular communications network; and
the cellular communications network comprises one of: a fourth generation (4G) wireless cellular network; a fifth generation (5G) wireless cellular network; a sixth generation (6G) wireless cellular network; a subsequent generation wireless cellular network; or any combination thereof.
